(19) United States
(12) Patent Application Publication
(10) Pub. No.: US 2009/0198757 A1
(43) Pub. Date: Aug. 6, 2009

(54) METHOD AND DEVICE FOR AVOIDING ROUNDING ERRORS AFTER PERFORMING AN INVERSE DISCRETE COSINE TRANSFORMATION

(76) Inventor: Thomas Sikora, Berlin (DE)

Correspondence Address: JOHN D. TITUS;THE CAVANAGH LAW FIRM, 1850 N. CENTRAL AVENUE, SUITE 2400, PHOENIX, AZ, 85004, US

(21) Appl. No.: 12/443,163

(22) PCT Filed: Oct. 18, 2007
(86) PCT No.: PCT/EP2007/009046

§ 371 Date: Mar. 26, 2009

(30) Foreign Application Priority Data
Oct. 18, 2006 (DE) 102006049232.3

(51) Int. Cl. G06F 17/14

(52) U.S. Cl. 708/402

(57) ABSTRACT

The present invention provides a method for avoiding rounding errors during rounding of values after performing an inverse discrete cosine transformation. In a first step a) coefficient values of a plurality of coefficients are summed up, wherein the coefficients belong to a block of coefficients. In a second step b), it is evaluated if the sum of the coefficient values is even numbered or odd numbered. In a third step c), then the coefficient block is transformed by means of the inverse discrete cosine transformation into a block of image pixels, wherein each image pixel comprises an image pixel value. In a fourth step d), a block of manipulation values is added or subtracted to the block of image pixel values of the block of image pixels, if the evaluation of the sum of the coefficient values has provided that the sum is even numbered, for generating a manipulated image pixel block, wherein the manipulation value block is formed such that rounding errors during a subsequent rounding operation can be avoided.

### FIELD OF THE INVENTION

The present invention relates to a method for avoiding of rounding errors after performing an inverse discrete Cosine Transformation, as well as an encoding device and a decoding device that use this method.

### TECHNICAL BACKGROUND

Due to bandwidth limitations a plurality of losless and lossy encoding techniques for transmitting of image/or audio material are known to reduce the amount of data to be transmitted. Many of the encoding methods use orthogonal transformations as for example the Fourier Transformation or the Cosine Transformation.

From the MPEG-1-Video-Standard (ISO/IEC 11172-2) and the MPEG-2-Video-Standard (ISO/IEC 13818-2) a large number of different methods are known to make video material free of redundancies, to reduce the amount of data and to guarantee a safe transmission via an air link or a storing device. The content of the MPEG-1-Video-Standard (ISO/IEC 11172-2) and the MPEG-2-Video-Standard (ISO/IEC 13818-2) are hereby enclosed by reference. Both MPEG-standards require the use of the inverse discrete Cosine Transformation (IDCT) within the decoder as inverse orthogonal transformation. However, they do not regulate the exact implementation but only describe the needed accuracy.

Often after the calculation of the inverse discrete cosine Transformation a rounding of the present real numbers to integer numbers is done. As the IEEE standard specification for the implementation of an 8×8 inverse discrete Cosine Transformation of 1990 describes—to which both the MPEG-1-standard and the MPEG-2-standard refer to—errors may appear during rounding of values, which are exactly between two integer numbers. It is known that encoders have an inverse path, which decodes an already encoded image. In this inverse path—like in the decoder—an inverse discrete Cosine Transformation is performed. If now values, which are exactly between two integer values, are rounded differently in the encoder compared to the decoder a matching error is generated, as it is described in the IEEE-specification.

MPEG-1 proposes for the reduction of such matching errors, that prior to the IDCT all coefficients are made odd numbered. Thereby the probability is reduced, that at the output IDCT values for image pixels appear, which are exactly between two integer numbers.

The EP 0 638 218 B1 describes a method to process a set of transformation coefficients and to provide an error-immune set of transformation coefficients for the processing by an inverse orthogonal transformation. This error immune set of transformation coefficients is according the EP 0 638 218 B1 immune against rounding errors during the inverse orthogonal transformation. In the method of the EP 0 638 218 B1 the transformation coefficients in a set are summed up and the parity of the sum is checked (i.e., if the sum is odd numbered or even numbered). If it is shown that the parity of the sum is even numbered then the parity of one of the transform coefficients in the set is inverted to obtain a parity inverted transformation coefficient. The parity inverted transformation coefficient makes the parity of the sum odd numbered. Finally, the set of transformation coefficients, including the parity inverted transform coefficient, is provided to the next following IDCT as an error-immune set.

### SUMMARY OF THE INVENTION

Starting from the prior art it is the problem of the present invention to provide an improved method for avoiding of rounding errors during the processing of an inverse discrete Cosine Transformation, as well as an encoding device and a decoding device which use this method.

The problem is solved according to the invention by the method for avoiding of rounding errors, which is described in independent patent claim 1. Preferred embodiments are described in the dependent claims.

According to a preferred embodiment the present invention provides a method for avoiding of rounding errors during rounding of values after performing an inverse discrete Cosine Transformation. In a first step a) coefficient values of a plurality of coefficients are summed up, wherein the coefficients belong to a block of coefficients. According to a preferred embodiment in this first step the sum of values of all coefficients in the corresponding block is determined. In a second step b) it is determined, if the sum of the coefficient values is even numbered or odd numbered. In a third step c) the block of coefficients is transformed by means of the inverse discrete Cosine Transformation into a block of image pixels, wherein each image pixel comprises an image pixel value. In a fourth step d), if the determination of the sum of the coefficient values has found that the sum is even numbered, a block of manipulation values is added to the image values of the block of image pixels or it is subtracted for the generation of a manipulated image pixel block, wherein the manipulation value block is made such that rounding errors during a subsequent rounding operation are avoided.

Preferably, the manipulation value block comprises values, who's signs are arranged in the form of a checkerboard pattern, wherein the modulus of the values decreases to the edges of the block. A particularly preferred manipulation value block consists of a square, symmetric matrix as it is for example shown in FIG. 4. The expression checkerboard pattern as it is used in this description, refers to an arrangement of the plus respectively minus signs of the manipulation values. According to a preferred embodiment the block of coefficients, the block of image pixels and the block of manipulation values is formed by a matrix of 8×8 values, respectively.

It is preferred in the fourth step d), if the determination of the sum of the coefficients has shown that the sum is odd numbered, if the value of a predetermined coefficient is even numbered to add the block of manipulation values to the image pixel values of the block of image pixels, and if the value of the predetermined coefficient is odd numbered to subtract the block of manipulation values from the image pixel values of the block of image pixels. In this way it can be guaranteed that none of the manipulated image pixel values has a value, which is exactly between two integer numbers, such that the subsequent rounding operation can be performed with a clearly determined result. In the rounding step e) the manipulated image pixel values of the manipulated image pixel block are rounded to an integer number, respectively. During this rounding step it is rounded preferably to the next integer number.

The present invention can also be used in a preferred way, to provide a compressed video signal, wherein at least the following steps are performed: Performing a prediction coding by means of a comparison of subsequent images, transforming of image blocks by means of a discrete Cosine Transformation into blocks of transformation coefficients, wherein for the prediction coding in an inverse path of the encoder, in which an encoded image is decoded, the method for avoiding of the rounding errors according to the invention is used. During the prediction coding a plurality of methods, for example motion compensation, block matching, interpolation etc. can be used.

It is preferred, that the compressed video signal is stored onto a storage medium, particularly an optically readable storage medium like a CD or a DVD. Alternatively the compressed video signal can be stored on a hard disc of a computer or for example on a magnetic tape. According to the invention further such a storage medium itself is provided, on which a compressed video signal according to the present invention is stored.

Further, the present invention provides an encoding device and a decoding device, respectively, which perform a method for avoiding of rounding errors according to the invention.

### BRIEF DESCRIPTION OF THE DRAWINGS

The enclosed drawings are only provided for a demonstration and for better understanding of the present invention and its advantages. They show:

FIG. 1 a schematic illustration of an encoder, in which the present invention is used;

FIG. 2 a schematic illustration of a decoder, in which the present invention is used;

FIG. 3 a schematic illustration of the technique for avoiding rounding errors, according to the present invention;

FIG. 4 an illustration of a block of manipulation values according to the present invention;

FIG. 5 a flow diagram, which illustrates the method for avoiding rounding errors according to the present invention.

### DETAILED DESCRIPTION OF THE PREFERRED EMBODIMENTS

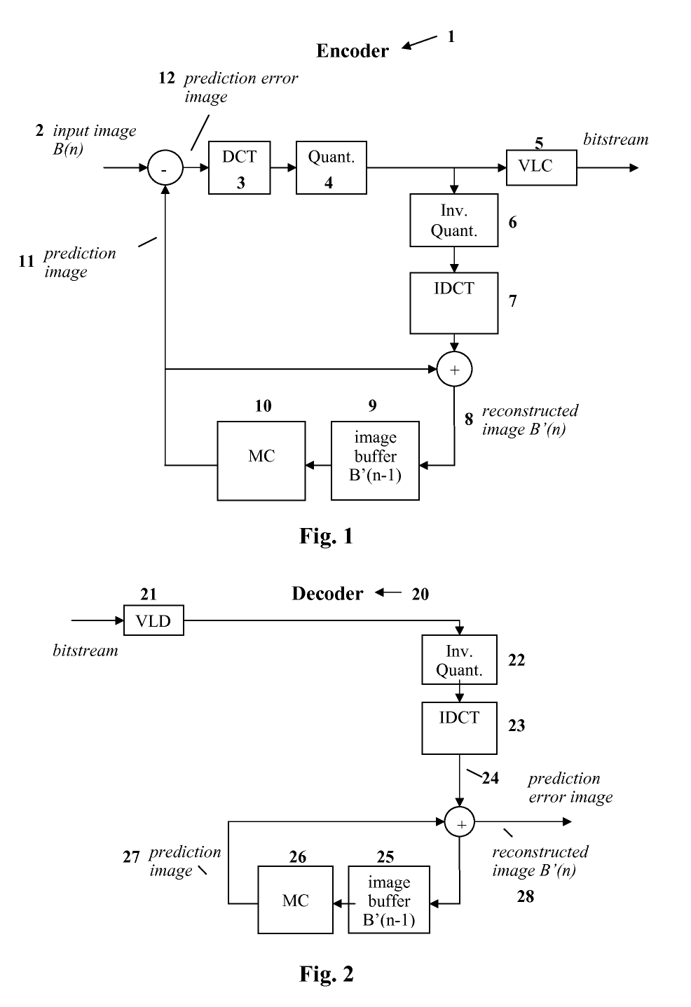

In FIG. 1 schematically the structure of a typical video encoder 1 is shown. A possibility to encode video images is for example an encoding according MPEG. The present description is only provided for a demonstration based on the background of a video encoder according MPEG but the application area of the present invention is not limited to such an encoding. The MPEG-2-standard provides three different types of images for the encoding, namely I-, P- and B-images. I-images are independently encoded from other images; they are processed by a so-called Intraencoding. P-images are predicted from a previous I-image, they are therefore dependent from a time wise preceding I-image. B-images can be dependent from a preceding and/or following I-, respectively P-image.

If a video-encoder 1, as shown in FIG. 1, is used for such an MPEG encoding i.e., P-images not the input image is encoded and transmitted but a prediction error image 12. From an already transmitted image within an image memory 9 by means of motion compensation (MC) 10 a prediction image 11 is generated. Displacements from one image to another image are described by motion vectors. The difference of input image 2 and prediction image 11 results in the prediction error image 12. The pixel values of the prediction error image 12 are transformed by means of DCT 3 and result in a set of transformation coefficients. These are quantized in a quantisizer 4. The quantized transformation coefficients and the motion vectors are converted into code words by means of a VLC (variable length coder) 5 and result in the bit stream for storing or transmission. Each image send to the decoder 20 must also be possibly exact be present in the encoder 1 within image memory 9 for the next prediction. Due to this reason the encoder 1 comprises also a local decoder, which reconstructs the decoder image B′(n) 8. The local decoder comprises an inverse quantisizer 6 and a device for performing an inverse discrete Cosine Transformation (IDCT) 7. The inventive method for avoiding of rounding errors during rounding of values after performing the IDCT is performed in the area of the local decoder, which comprises the inverse quantisizer 6 and the IDCT 7. A comparison with FIG. 2 shows, that the local decoder blocks of the encoder in principle correspond to the blocks of the decoder.

FIG. 2 shows schematically the basic structure of a typical video decoder 20. The incoming bit stream transports—among others—information of the motion vectors and the prediction error images. A variable length decoder (VLD) 21 converts the bit stream into quantisizer values and motion vectors. The quantisizer values are converted by the inverse quantisizer 22 into a set of transformation coefficients and after that by means of an inverse DCT (IDCT) 23 into pixels of the prediction error image 24. The reconstructed image 28 results from an addition of the prediction image 27 and the prediction error image 24. The prediction image 27 is generated by means of motion compensation (MC) 26 from the previous reconstructed image, which is stored in the image memory 25. Like in the encoder 1 also in the decoder 20 the method for avoiding rounding errors according to the invention during rounding of values after performing the IDCT in the area of the IDCT 23 is used.

As it is shown in FIGS. 1 and 2, the encoder 1 as well as the decoder 20 comprises an IDCT block 7, respectively 23. From the coefficients, which are processed by the inverse quantisation by means of the IDCT, pixel values (which are also called image pixel values) are reconstructed. This calculation is done with a finite accuracy. To reduce the calculation and storage effort in the course of the further processing, the pixel values achieved by the IDCT 7, 23 are rounded. Preferably each pixel value is rounded to an integer number. Such a rounding step is performed in the encoder 1 and in decoder 20. The implementation of the IDCT 7, 23 as well as the subsequent rounding operations can, however, be different in encoder 1 and in decoder 20 since they are produced i.e., by different manufacturers. Due to such different implementations different results can appear at values, which are in a small range exactly between two values to which they can be rounded. Therefore, it can be dependent on the implementation of the rounding operation, if a value is rounded up or rounded down. If in encoder 1 and in decoder 20 after the rounding a different value appears, this is called an adaptation error.

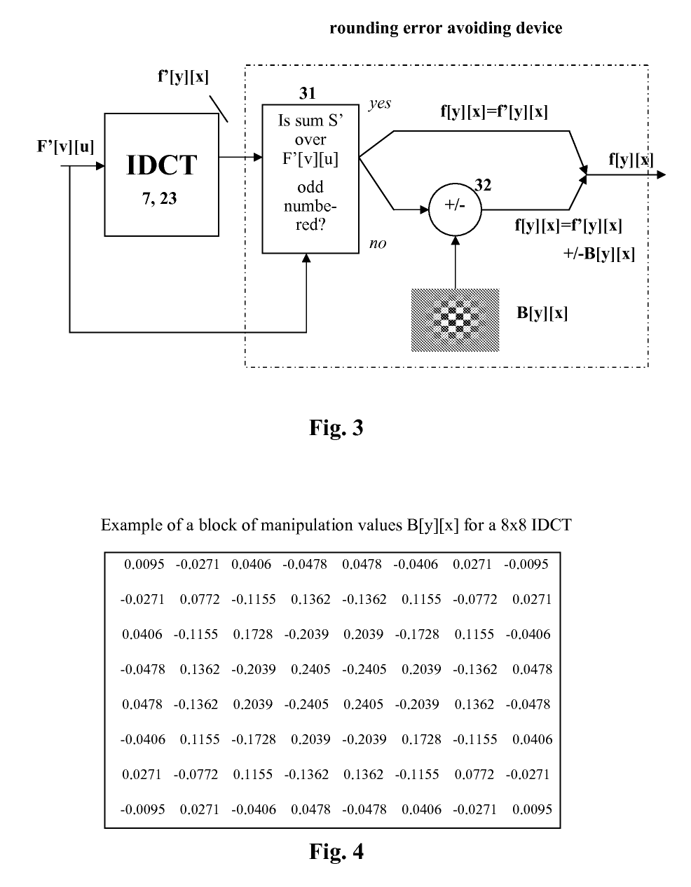

FIG. 3 describes a preferred embodiment of the method according the present invention, by which the possibility of adaptation errors can be reduced. A block of coefficient values F′ [v][u], wherein v and u for example are integer numbers in the area of 0, 1, . . . , 7 is processed by the inverse discrete Cosine Transformation (IDCT), 7, 23. The result of the IDCT 7, 23 is a block of coefficient values f′[y][x], which are preferably real numbers with a finite accuracy. Further a sum S′ is formed of the coefficient values F′ [v][u]. Then in a device for checking the parity 31 it is evaluated if the value of the sum S′ is even numbered or odd numbered. If the sum S′ is odd numbered, the image pixel values are unchanged, i.e., f[y][x]=f′[y][x] is given. If the sum S′, however, is even numbered, a block of manipulation values B[y][x] is added respectively subtracted from the block of image pixel values f′[y][x] by an adder respectively subtracter 32, to obtain a manipulated image pixel value block, f[y][x]=f′[y][x]+/−B[y][x]. The manipulated image pixel values f[y][x] are subsequently rounded, wherein the manipulated image pixel values are equal to the image pixel values f′[y][x] in case of an odd numbered sum S′. Due to the manipulation of the image pixel values it is avoided, that image pixel values are exactly between two integer values, respectively, in a small area exactly in between two integer values. Thereby, the result of the rounding operation is independent from the implementation of the IDCT 7, 23 and from the subsequent rounding operation, whereby by the present invention the appearance of adaptation errors is avoided.

In the embodiment of FIG. 3 a 8×8 fixed image pattern B [y][x] (checkerboard pattern) is overlaid to the reconstructed pixel values in the 8×8 block f′[y][x], if the sum of the values of the coefficient block F′[v][u] is even numbered, wherein v and u are integer numbers in the range of 0, 1, . . . 7. The rounding to integer numbers is performed on the basis of the manipulated image pixel values f[y][x]. FIG. 4 shows an example for a manipulation value block, as it can be used for the present invention. The values are rounded to four digits after the comma for a better overview. The example of FIG. 4 is considered not to be limiting, but should only describe a particularly preferred manipulation value block. The exact used values can for example be generated by a numeric optimisation. The example of FIG. 4 also makes clear, that for the case of an 8×8 IDCT preferably a square matrix of manipulation values B[y][x] of the size 8×8 is used, which is symmetric. The signs of the single values are arranged like a checkerboard pattern, wherein the value on top left has a positive sign. Additionally, the values of the shown matrix decrease to the outside with respect to their modulus. The exemplary matrix shown with a higher accuracy than in FIG. 4 and read line wise from top left is the following:

| | | | |
|---|---|---|---|
| 0.009515058436089 | −0.02709659391559 | 0.04055291860268 | −0.04783542904564 |
| 0.04783542904564 | −0.04055291860268 | 0.02709659391559 | −0.009515058436089 |
| −0.02709659391559 | 0.07716457095436 | −0.1154849415639 | 0.1362237766940 |
| −0.1.362237766940 | 0.1154849415639 | −0.07716457095436 | 0.02709659391559 |
| 0.04055291860268 | −0.1154849415639 | 0.1728354290456 | −0.2038732892122 |
| 0.2038732892122 | −0.1728354290456 | 0.1154849415639 | −0.04055291860268 |
| −0.04783542904564 | 0.1362237766940 | −0.2038732892122 | 0.2404849415639 |
| −0.2404849415639 | 0.2038732892122 | −0.1362237766940 | 0.04783542904564 |
| 0.04783542904564 | −0.1362237766940 | 0.2038732892122 | −0.2404849415639 |
| 0.2404849415639 | −0.2038732892122 | 0.1362237766940 | −0.04783542904564 |
| −0.04.055291860268 | 0.1154849415639 | −0.1728354290456 | 0.2038732892122 |
| −0.2038732892122 | 0.1728354290456 | −0.1154849415639 | 0.04055291860268 |
| 0.02709659391559 | −0.07716457095436 | 0.1154849415639 | −0.1362237766940 |
| 0.1362237766940 | −0.1154849415639 | 0.07716457095436 | −0.02709659391559 |
| −0.009515058436089 | 0.02709659391559 | −0.04055291860268 | 0.04783542904564 |
| −0.04783542904564 | 0.04055291860268 | −0.02709659391559 | 0.009515058436089 |

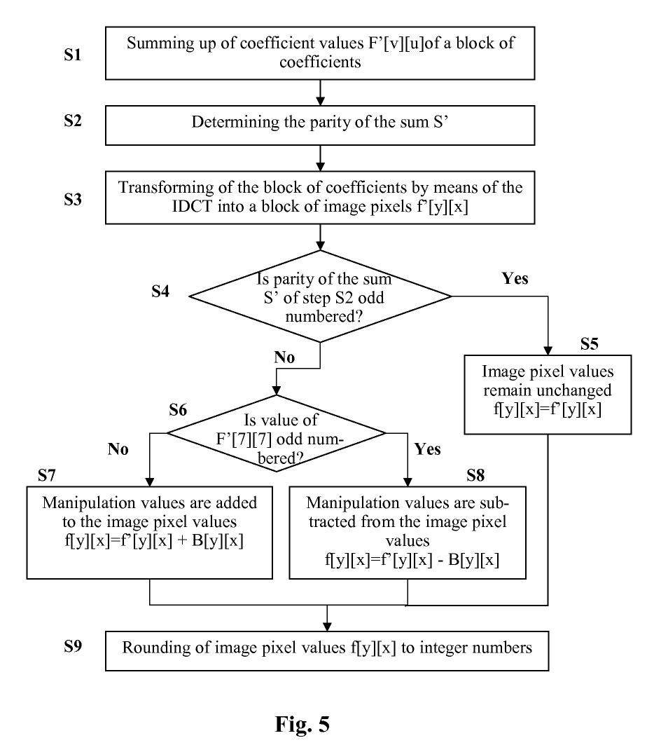

FIG. 5 shows a flow diagram, in which the flow of the inventive method—like it is used in encoder 1, respectively, in the decoder 20—is illustrated. In step S1, the coefficient values F′[v][u], which are a result of the inverse quantisation 6 respectively 22, are summed up. After that, in step S2, the parity of the sum S′ is checked, i.e., if the sum is even numbered or odd numbered. As it will be clear from the further description, the result of this evaluation in step S2 is not used until step S4 for a decision, therefore the sequence of the step S2 and S3 can also be exchanged. In step S3 the coefficients F′[v][u] are transformed by means of IDCT 7 respectively 23 into a block of image pixels f′[y][x]. As already mentioned, in step S4 a decision is rendered dependent on the fact, whether the parity of the sum S′ according the evaluation in step S2 is odd numbered respectively even numbered. If the parity is odd numbered the process proceeds with step S5 and the image pixel values remain unchanged f[y][x]=f′[y][x]. If, however, in step S4 it is determined, that the parity of the sum S′ from step S2 is not odd numbered—therefore even numbered—the processing proceeds with step S6.

In step S6 it is checked, if the value of the coefficient F′[7][7] is odd numbered. This coefficient F′[7][7] can either be checked prior the processing of the IDCT 7 respectively 23 to its parity, wherein the result of this evaluation is buffered, or a copy of the coefficient F′[7][7] can be buffered. If the value of the coefficient F′[7][7] from the frequency range is even numbered the processing proceeds with step S7, where the manipulation value block B[y][x] is added to the image pixel value block f′[y][x] to obtain a block of manipulated image pixels f[y][x], f[y][x]=f′[y][x]+B[y][x]. If, however, in step S6 is determined, that the value of the coefficient F′[7][7] is odd numbered, step S8 is performed, where the manipulation value block B[y][x] is subtracted from the image pixel value block f′[y][x] to achieve a block of manipulated image pixels f[y][x], f[y][x]=f′[y][x]−B[y][x].

Subsequently to the step S5, S7 respectively S8 in step S9 the image pixel values f[y][x] are rounded respectively to the next integer number. Thereby, each number which is larger than 0.5 is rounded to the next larger integer number, wherein each number which is smaller than 0.5 is rounded to the next smaller integer number. By means of the method of the present invention it is avoided, that image pixel values are present for the rounding, which are exactly in between two integer numbers, such that adaptation errors are avoided independently from the exact implementation.

1. Method for avoiding of rounding errors during rounding of values after performing an inverse discrete cosine transformation (7, 23), whereby the method comprises the subsequent steps:
(a) summing up of coefficient values of a plurality of coefficients, wherein the coefficients belong to a block of coefficients (S1),
(b) determining of the sum of the coefficient values, if the sum is even numbered or odd numbered (S2),
(c) transforming of the block of coefficients by means of the inverse discrete cosine transformation (7, 23) into a block of pixels, wherein each image pixel comprises an image pixel value (S3), and
(d) if determination of the sum of the coefficient values has shown that the sum is even numbered (S4), adding or subtracting of a block of manipulation values to the image pixel values of the block of image pixels, for generating a manipulated image pixel block, wherein the manipulation value block is formed such that rounding errors during a subsequent rounding operation are avoided (S6, S7, S8).

2. Method according to claim 1, wherein the manipulation value block comprises values, whose signs are arranged in form of a checkerboard pattern, wherein the moduli of the values decrease to the edges of the block.

3. Method according to claim 2, wherein the manipulation value block consists of square, symmetric matrix.

4. Method according to claim 2, wherein the block of coefficients, the block of image pixels and the block of manipulation values are respectively formed by a matrix of 8×8 values.

5. Method according to claim 1, wherein in step a) the sum is calculated over all coefficients of the block of coefficients.

6. Method according to claim 1, wherein in step d), if the evaluation of the sum of the coefficient values has shown that the sum is even numbered (S4), if the value of one predetermined coefficient is even numbered the block of manipulation values is added to the image pixel values of the block of image pixels (S7), and if the value of a predetermined coefficient is odd numbered the block of manipulation values is subtracted from the image pixel values of the block of image pixels (S8).

7. Method according to claim 1, further comprising the following step:
e) rounding of each manipulated image pixel value of the manipulated image pixel block to an integer number (S9).

8. Method for providing a compressed video signal, which comprises the following steps:
Performing of a prediction coding by means of a comparison of subsequent images, transforming of image blocks by means of a discrete cosine transformation into blocks of transformation coefficients,
wherein for the prediction coding in an inverse path of the encoder, in which an image to be encoded is decoded, the method for avoiding of rounding errors according to claim 1 is used.

9. Method according to claim 8, wherein the compressed video signal further is stored on a storage medium, particularly an optically readable storage medium.

10. A storage medium comprising:
a physical storage medium on which the compressed video signal according to claim 8 is stored.

11. A decoding device comprising:
an electronic decoding device in which for avoiding of rounding errors the method according to claim 1 is performed.

12. A coding device comprising:
an electronic coding device in which for avoiding of rounding errors the method according to claim 1 is performed.
